(19) United States
(12) Patent Application Publication
(10) Pub. No.: US 2025/0367987 A1
(43) Pub. Date: Dec. 4, 2025

(54) APPARATUS FOR DETECTING IMBALANCE OF TIRE ROTATION AND METHOD THEREOF, AND VEHICLE HAVING THE SAME

(71) Applicant: HL MANDO CORPORATION, Gyeonggi-do (KR)

(72) Inventor: Jehyun BANG, Gyeonggi-do (KR)

(21) Appl. No.: 18/967,652

(22) Filed: Dec. 4, 2024

(30) Foreign Application Priority Data
May 30, 2024 (KR) 10-2024-0070527

(51) Int. Cl. B60C 23/06; B60C 23/04

(52) U.S. Cl. CPC B60C 23/062; B60C 23/0435

(57) ABSTRACT

The present disclosure relates to a tire rotation imbalance detection device and method, and a vehicle provided therewith. A device according to one embodiment of the present disclosure is a device provided in a vehicle, including a memory and a processor configured to perform processing to detect whether tire rotation imbalance occurs using information stored in the memory. The processor is configured to identify an angular velocity (ω) of each of a plurality of tires of the vehicle over time using a sensor signal from a wheel speed sensor installed on the tire, perform Fourier transform on the angular velocity (ω), and determine whether tire rotation is imbalanced based on signal magnitudes of frequency signals included in a reference region according to the Fourier transform in a frequency domain.

### CROSS-REFERENCE TO RELATED APPLICATION

This application claims priority to and the benefit of Korean Patent Application No. 10-2024-0070527, filed on May 30, 2024, the disclosure of which is incorporated herein by reference in its entirety.

### BACKGROUND

### 1. Technical Field

The present disclosure relates to a technology for detecting rotation imbalance of tires.

### 2. Discussion of Related Art

Vehicles are provided with various sensors to detect the state of the vehicles. However, despite the fact that various sensors for vehicles are provided, there is virtually no sensor of warning of tire rotation imbalance in the vehicle in real time.

In this case, the tire rotation imbalance is a phenomenon that occurs when a specific tire rotates as the vehicle travels due to various failure states of the tire. Since the tire rotation imbalance may lead to phenomena such as inability to steer or a sudden shift of the vehicle's center of gravity, a serious vehicle accident may occur.

Meanwhile, in a method of determining tire rotation imbalance in the related art (hereinafter referred to as “the related art”), tire pressure is monitored. In this case, a tire pressure monitoring system (TPMS) uses a method (wheel radius analysis (WRA)) of estimating the amount of change in dynamic radius by comparing wheel speed values and estimating tire pressure through the comparison, a method (wheel spectrum analysis (WSA)) of independently estimating tire pressure by estimating a tire resonance frequency using a wheel speed value of each wheel, or the like.

However, in the technology based on the TPMS in the related art, when the air pressure of all tires of a vehicle (e.g., four tires in the case of a four-wheel drive vehicle) is equally reduced, there is a problem in that it is difficult to determine whether the tire pressure has been decompressed through relative analysis of a turning radius, and accordingly, it is difficult to determine tire rotation imbalance. Therefore, since it is difficult to accurately determine tire rotation imbalance simply by monitoring tire pressure according to the related art, a new technology to replace the related art is required.

Meanwhile, in order to implement the new technology, a method of mounting a new type of sensor for detecting tire rotation imbalance on a vehicle may be explored. However, in this case, since a structure within the vehicle has to be changed, the method is not only cumbersome and inefficient, but also significantly increases manufacturing costs.

However, the above-described content simply provides background information on the present disclosure and does not correspond to a previously disclosed technology.

### SUMMARY

In order to solve the aforementioned problem, the present disclosure is directed to providing a new technology capable of detecting tire rotation imbalance.

In particular, the present disclosure is directed to providing a technology capable of detecting tire rotation imbalance using sensor signals from an existing mounted wheel speed sensor without adding a separate sensor to a vehicle.

However, problems to be solved in the present disclosure are not limited to the problems mentioned above, and other problems to be solved that are not mentioned will be clearly understood by those of ordinary skill in the art to which the present disclosure belongs from the following description.

In order to solve the aforementioned problems, according to an aspect of the present disclosure, there is provided a device provided in a vehicle including a memory and a processor configured to perform processing to detect whether tire rotation imbalance occurs using information stored in the memory.

The processor may be configured to identify an angular velocity (ω) of each of a plurality of tires of the vehicle over time using a sensor signal from a wheel speed sensor installed on the tire, perform Fourier transform on the angular velocity (ω), and determine whether the tire rotation is imbalanced based on signal magnitudes of frequency signals included in a reference region according to the Fourier transform in a frequency domain.

The processor may identify the angular velocity (ω) based on the number of pulses (N) included in the sensor signal and a time interval (Tᵢ) between each pulse.

The pulse may be a signal corresponding to a tooth provided on a tone wheel rotating in conjunction with the tire.

The processor may sample secondary samples for a plurality of additional angular velocities between each primary sample based on primary samples according to each of the identified angular velocities, and then perform Fourier transform on the primary and secondary samples.

The secondary samples may be sampled using an interpolation method.

The processor may divide a region with a higher frequency range than a rotational frequency component (F_{R}) of the tire according to a traveling speed in the frequency domain into the reference region.

A frequency of the rotational frequency component (F_{R}) in the frequency domain may be proportional to the traveling speed and inversely proportional to a circumference length of the tire.

The processor may determine whether the tire rotation is imbalanced according to whether a signal magnitude of a harmonic component for the rotational frequency component in the reference region increases more than a reference.

The processor may determine whether the tire rotation is imbalanced according to whether signal magnitudes of the harmonic component and other frequency signals in the reference region increase more than the reference.

The processor may identify a representative value for the magnitudes of the frequency signals included in the reference region and determine whether the tire rotation is imbalanced according to whether the identified representative value increases more than the reference.

The representative value may include at least one of a root mean square (RMS) value, a peak-to-peak level value, a peak level value, or an average level value for the frequency signals in the reference region.

The processor may apply a band pass filter (BPF) to the reference region.

The processor may generate a control signal for notification of imbalance when it is determined that the tire rotation imbalance occurs.

According to another aspect of the present disclosure, there is provided a method performed by a device provided in a vehicle to detect whether tire rotation imbalance occurs, including identifying an angular velocity (ω) of each of a plurality of tires of the vehicle over time using a sensor signal from a wheel speed sensor installed on the tire, performing Fourier transform on the angular velocity (ω), and determining whether the tire rotation is imbalanced based on signal magnitudes of frequency signals included in a reference region according to the Fourier transform in a frequency domain.

In the identifying, the angular velocity (ω) may be identified based on the number of pulses (N) included in the sensor signal and a time interval (Tᵢ) between each pulse.

In the performing, secondary samples for a plurality of additional angular velocities between each primary sample may be sampled based on primary samples according to each of the identified angular velocities, and then Fourier transform may be performed on the primary and secondary samples.

The reference region may be a region with a higher frequency range than a rotational frequency component (F_{R}) of the tire according to a traveling speed in the frequency domain.

In the determining, a determination as to whether the tire rotation is imbalanced may be made according to whether a signal magnitude of a harmonic component for the rotational frequency component in the reference region increases more than a reference.

In the determining, a representative value for the magnitudes of frequency signals included in the reference region may be identified and a determination as to whether the tire rotation is imbalanced may be made according to whether the identified representative value increases more than the reference.

According to still another aspect of the present disclosure, there is provided a vehicle including a wheel speed sensor installed on each of a plurality of tires to detect a sensor signal and a detection device configured to detect whether tire rotation imbalance occurs using the sensor signal.

The detection device may be configured to identify an angular velocity (ω) of each of the plurality of tires of the vehicle over time using the sensor signal from the wheel speed sensor installed on the tire, perform Fourier transform on the angular velocity (ω), and determine whether the tire rotation is imbalanced based on signal magnitudes of frequency signals included in a reference region according to the Fourier transform in a frequency domain.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic view of a system (1) according to one embodiment of the present disclosure;

FIG. 2 shows a flowchart of a method according to one embodiment of the present disclosure;

FIG. 3 shows one example of primary and secondary samples;

FIG. 4 shows one example of angular velocities (o) calculated in the case of a vehicle speed of 37 km/h in a normal state without wheel nut loosening and in a state of wheel nut loosening of a right front wheel, respectively, in a frequency domain;

FIG. 5 shows a conceptual view of a root mean square (RMS), a peak-to-peak level, a peak level, and an average level; and

FIG. 6 shows one example of frequency signals passing a band pass filter (BPF) in FIG. 4.

### DETAILED DESCRIPTION

The objects and means of the present disclosure and advantages according thereto will be more obvious from the following detail descriptions with reference to the accompanying drawings, and accordingly, the technical concept of the present disclosure may be easily practiced by those skilled in the art to which the present disclosure pertains. In describing the present disclosure, when it is determined that the detailed description of the known technology related to the present disclosure may unnecessarily obscure the subject matter of the present disclosure, the detailed description thereof will be omitted.

The terms used in the present specification are for the purpose of describing the embodiments only and are not intended to limit the present disclosure. In the present specification, the singular forms “a,” “an,” and “the” are intended to include the plural forms as well as appropriate, unless the context clearly indicates otherwise. In this specification, terms such as “comprise,” “include,” “provide,” or “have” do not exclude the presence or addition of one or more other components other than mentioned components.

In the present specification, terms such as “of” and “at least one” may represent one of words listed together, or a combination of two or more. For example, “A or B” and “at least one of A and B” may include only A or B, or include both A and B.

In the present specification, the description following “for example” may not exactly match the information presented, such as the recited characteristics, variables or values, and the exemplary embodiments of the disclosure according to various examples of the present disclosure should not be limited to effects such as variations including tolerances, measurement errors, limitations of measurement accuracy and other commonly known factors.

In the present specification, it will be understood that when an element is described as being “coupled” or “connected” to another element, the element may be directly coupled or connected to the other element, or intervening elements may also be present. In contrast, it will be understood that when an element is referred to as being “directly coupled” or “directly connected” to another element, there are no intervening elements present.

In the present specification, it will be understood that when an element is described as being “on” or “adjacent to” another element, the element may be directly in contact with or connected to another component, or still another component may exist therebetween. In contrast, it may be understood that when an element is described as being “directly above” or “directly adjacent to” another component, still another component does not exist therebetween. Other expressions describing the relationship between elements, such as “between” and “directly between,” may be interpreted in the same manner.

In the present specification, it will be understood that, although the terms “first,” “second,” etc. may be used to describe various elements, these elements should not be limited by these terms. In addition, the above terms should not be interpreted as limiting the order of each component, and may be used for the purpose of distinguishing one element from another element. For example, a “first element” may be named a “second element,” and similarly, a “second element” may also be named a “first element.”

Unless otherwise defined, all terms used in the present specification may be used as the same meaning as commonly understood by one of ordinary skill in the art to which the present disclosure pertains. In addition, it will be further understood that terms, such as those defined in commonly used dictionaries, will not be interpreted in an idealized or overly formal sense unless expressly so defined herein.

Hereinafter, one exemplary embodiment according to the present disclosure will be described in detail with reference to the accompanying drawings.

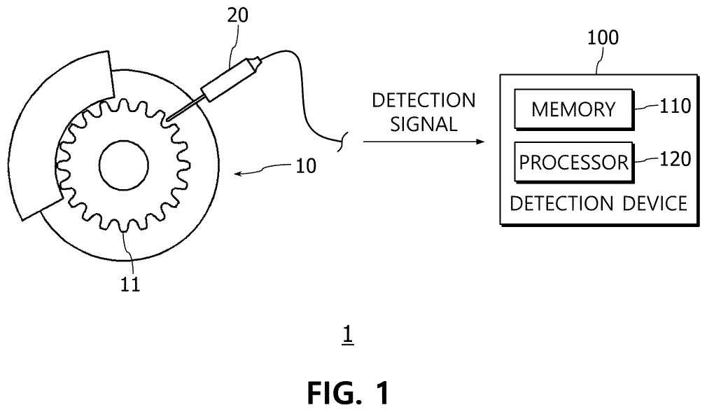

FIG. 1 is a schematic view of a system 1 according to one embodiment of the present disclosure.

The system 1 according to one embodiment of the present disclosure (hereinafter referred to as the “system 1”) is a system provided in a vehicle and is a system for detecting rotation imbalance of tires. In this case, the tire rotation imbalance is a phenomenon that occurs when a specific tire rotates as the vehicle travels due to various failure states of the tire. Accordingly, tire rotation imbalance may mean an imbalance in which tire rotation is uneven even when the vehicle speed is the same.

In one example, a failure state in which tire rotation imbalance occurs may be a state in which a tire wheel nut is loosened, a state in which the tire wheel is out of balance, or a state in which the tire touches the wheel or the ground due to a tire puncture, or the like. That is, when the vehicle travels in the failure state and the tire rotates, rotation imbalance may occur in the tire in the failure state. Of course, tire rotation imbalance may appear separately for each tire provided on the vehicle, and accordingly, the system 1 may operate to individually detect whether the tire rotation imbalance occurs for each tire.

Referring to FIG. 1, in order to detect tire rotation imbalance, the system 1 may include a tone wheel 10, a wheel speed sensor (WSS) 20, and a tire rotation imbalance detection device 100 (hereinafter referred to as a “detection device 100”).

The tone wheel 10 is a device mounted on a rotating object such as a drive shaft, hub bearing, or the like, of a vehicle to monitor the number of rotations of each wheel in the vehicle. The tone wheel 10 is mounted on an axle and rotates in sync with the rotation of the wheel. In particular, the tone wheel 10 includes a plurality of teeth 11 spaced apart from each other. The teeth 11 are provided along an outer peripheral surface of the tone wheel 10 and rotate together with the rotation of the axle. In one example, the teeth 11 may be configured as an uneven structure (see FIG. 1), but are not limited thereto and may be configured as a magnet structure, a composite structure, or the like.

In this case, the uneven structure is a structure in which protruding parts and recessed parts are alternately formed along the outer peripheral surface. In the uneven structure, one protruding part or one recessed part corresponds to one tooth 11. Of course, in general, one protruding part corresponds to one tooth 11. However, an opening may be formed in place of the recessed part, or an additional opening may be formed within the protruding part or the recessed part. For convenience, the cases may also be classified as corresponding to the uneven structure.

The magnet structure is a structure configured to distinguish each tooth 11 through a magnet. In one example, the magnet structure may include first and second magnet structures. In this case, the first magnet structure is a structure in which two neighboring teeth 11 are magnets of different electrodes. That is, the first magnet structure is a structure in which a first magnet part provided with a first electrode on an outer circumferential surface thereof and a second magnet part provided with a second electrode (an electrode having a different polarity from the first electrode) on an outer peripheral surface thereof are alternately formed. In the first magnet structure, one first magnet part corresponds to one tooth 11 and one second magnet part corresponds to another tooth 11. Of course, neighboring first and second magnet parts may be in contact with each other or may be spaced apart from each other.

The second magnet structure is a structure of being disposed to be spaced apart along the outer peripheral surface using only the first magnet part without the second magnet part. That is, the second magnet structure is a structure in which the first magnet part and a non-magnet part are disposed to be spaced apart along the outer peripheral surface. In the second magnet structure, one first magnet part corresponds to one tooth 11.

The composite structure is a structure including compositely the uneven structure and the magnet structure. In one example, the composite structure may include a first composite structure and a second composite structure. In this case, the first composite structure is a structure in which a magnet part is provided at the protruding part or the recessed part in the uneven structure. On the other hand, the second composite structure is a structure in which the first magnet part is provided at the protruding part and the second magnet part is provided in the recessed part in the uneven structure.

The wheel speed sensor 20 is a sensor that is mounted on the axle and outputs an electrical signal capable of detecting a rotational speed of the wheel. The wheel speed sensor 20 may be installed on a radial outer side of the tone wheel 10 at a predetermined distance apart.

That is, the wheel speed sensor 20 detects an alternating current sensor signal generated by the tone wheel 10 that rotates according to the movement of the wheel, and transmits the detected sensor signal to the detection device 100. In this case, the sensor signal may be recognized as a high-low signal that changes depending on the rotational speed of the wheel. That is, the sensor signal capable of distinguishing each tooth 11 of the tone wheel 10 according to the rotation of the tone wheel 10 may be generated from the wheel speed sensor 20. This is because as each tooth 11 of the tone wheel 10 is configured in the uneven structure, the magnet structure, or the composite structure as described above, electrical or magnetic characteristics changed by each tooth 11 may be detected by the wheel speed sensor 20.

Of course, the tone wheel 10 and the wheel speed sensor 20 are individually provided on each wheel of the vehicle. For example, in the case of a four-wheel drive vehicle, the tone wheel 10 and the wheel speed sensor 20 may be provided on each of a left front wheel, a right front wheel, a left rear wheel, and a right rear wheel.

The detection device 100 is a device that operates to receive a sensor signal detected by the wheel speed sensor 20 and detect (that is, determine) whether tire rotation is imbalanced based on data (that is, sensor data) according to the received sensor signal. That is, the detection device 100 is a device that is built inside the vehicle and performs computing to determine whether rotation is imbalanced for each tire based on the sensor signal from each wheel speed sensor 20. In one example, the detection device 100 may be implemented as an electronic control unit (ECU) or the like. To this end, as shown in FIG. 1, the detection device 100 may include a memory 110 and a processor 120.

The memory 110 stores various information necessary for the operation of the detection device 100. In this case, the information stored in the memory may include sensor data, information for the operation of the detection device 100, program information related to a method to be described below, and the like, but is not limited thereto.

For example, the memory 110 may include a volatile memory device such as a DRAM, an SRAM, or the like, a non-volatile memory such as a PRAM, an MRAM, an ReRAM, a NAND flash memory, or the like, a hard disk drive (HDD) or a solid state drive (SSD), but is not limited thereto. In addition, the memory 110 may be a cache, a buffer, a main memory, an auxiliary memory, or the like, depending on its purpose/location, but is not limited thereto.

The processor 120 may perform various control operations on the detection device 100 using information stored in the memory 110. That is, the processor 120 may execute a program stored in the memory 110 to control at least one other component (e.g., a hardware or software component) of the detection device 100 and perform various data processing or computation. In one example, the processor 120 may be implemented as a micro controller unit (MCU), but is not limited thereto.

For example, the system 1 may be a system for controlling the traveling of a vehicle. In this case, the system 1 may additionally include a caliper that applies a braking force to each wheel, a pedal sensor that detects the degree of movement of a brake pedal when a pressing force is applied to the brake pedal, a motor that provides a driving force to the wheel, or the like. Accordingly, the processor 120 may receive sensor signals from various sensors, such as the pedal sensor and the like, in addition to the wheel speed sensor 20, and perform traveling control of the vehicle based on the received signals.

In particular, the processor 120 may determine whether the rotation of each tire is imbalanced using sensor data from the wheel speed sensor 20. That is, the processor 120 may receive a sensor signal from the wheel speed sensor 20 installed on each of the plurality of tires of the vehicle, identify the number N of pulses (where N is a natural number of 2 or more) and a time interval Tᵢ between each pulse while the tire rotates for a certain period of time from the sensor data according to the received sensor signal, and calculate the angular velocity ω of the tire based on the number N of identified pulses (where N is a natural number of 2 or more) and the identified time interval Tᵢ between each pulse. In addition, the processor 120 may perform Fourier transform on the time domain of the calculated angular velocity ω and determine whether tire rotation of a specific tire is imbalanced based on a representative value of frequency signals included in a reference region R in the frequency domain according to the corresponding Fourier transform.

Hereinafter, a method according to one embodiment of the present disclosure will be described in more detail.

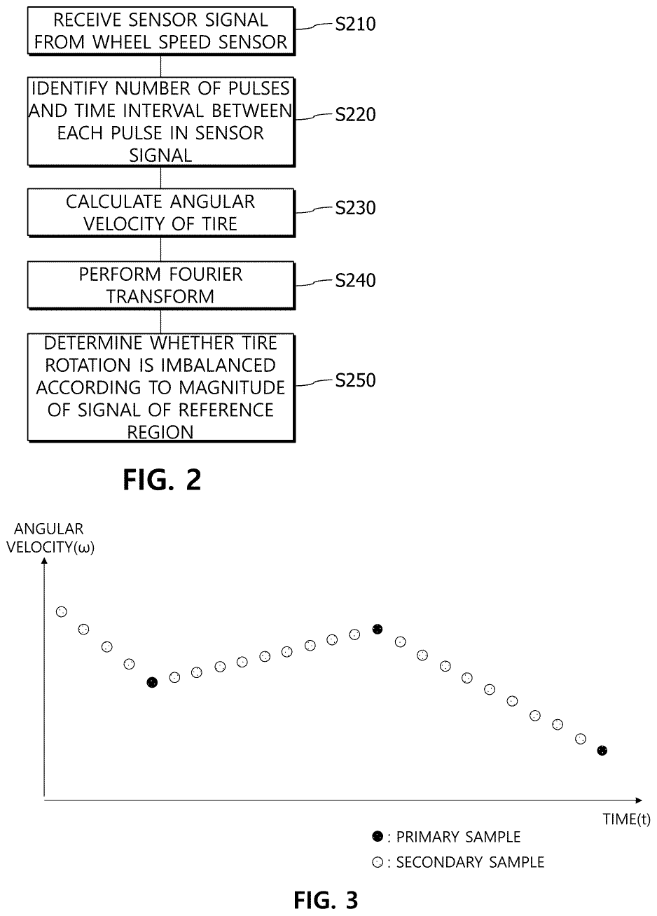

FIG. 2 shows a flowchart of a method according to one embodiment of the present disclosure.

The method according to one embodiment of the present disclosure (hereinafter referred to as a “the present method”) is a method performed in the detection device 100 under the control of the processor 120. That is, the present method is a method for detecting tire rotation imbalance using a sensor signal from an existing mounted wheel speed sensor 20 without adding a separate sensor to the vehicle. Accordingly, the method may alternatively be referred to as a “detecting method.”

Referring to FIG. 2, the method may include S210 to S250. Of course, information about S210 to S250 may be stored in the memory 110, and accordingly, the processor 120 may process the execution of S210 to S250 using the information stored in the memory 110.

In S210, the processor 120 receives a sensor signal from the wheel speed sensor 20 installed on each of a plurality of tires of the vehicle. Sensor data according to the sensor signal may be stored in the memory 110.

In one example, the processor 120 may receive the sensor signal from the wheel speed sensor 20 through controller area network (CAN) communication, local interconnect network (LIN) communication, Ethernet communication, FlexRay communication, or the like, but the communication is not limited thereto. However, for convenience of description, in the following, the contents of processing using the wheel speed sensor 20 of any one tire will be described. Accordingly, such any one tire will be referred to as a “specific tire.” Of course, the contents to be described below applies equally to other tires.

Then, in S220 to S250, the processor 120 performs processing for detecting whether tire rotation imbalance occurs using the information stored in the memory 110. In particular, the processor 120 may perform processing regarding whether rotation of the specific tire is imbalanced using sensor data according to the corresponding sensor signal.

That is, in S220, the processor 120 identifies the number N of pulses (where N is a natural number of 2 or more) in the corresponding sensor signal while the specific tire rotates for a certain period of time using the sensor data according to the received sensor signal and a time interval Tᵢ between each pulse. In one example, the certain period of time may be a period of time it takes for the specific tire to rotate once. In this case, the certain period of time may vary depending on the current traveling speed of the vehicle (that is, the tire rotation speed).

In this case, a plurality of teeth 11 are provided on the tone wheel 10, and one pulse is detected as a sensor signal for one tooth 11, and during the certain period of time, pulses for N teeth may be included in the sensor signal. In addition, in the N pulses, the time interval Tᵢ between pulses means a time interval between neighboring pulses.

In one example, one pulse in a sensor signal may include a high signal having a signal value equal to or greater than a first reference and a low signal equal to or less than a second reference. Accordingly, the processor 120 may identify the number N of pulses generated during the certain period of time in the corresponding sensor signal from sensor data according to the received sensor signal and identify the time interval Tᵢ between each pulse for the identified number N. Hereinafter, the number of pulses and the time interval between each pulse identified in this way may be differently referred to as an “input signal.” Of course, the processor 120 may receive sensor signals at predefined periods, and at each period, update identification of the number N of pulses for the certain period of time and the time interval Tᵢ between each pulse.

In S230, the processor 130 calculates an angular velocity ω for rotation of the specific tire using the input signal. In this case, the angular velocity ω may correspond to the angular velocity of the specific tire. To this end, the processor 130 may calculate the corresponding angular velocity ω using an angle α between each tooth of the tone wheel 10 and the time interval Tᵢ between each pulse identified in S220.

In this case, the angle α corresponds to an angle between neighboring pulses in N pulses identified during the certain period of rotation for the specific tire, and may be expressed as a radian value. The angle α may be pre-stored as a fixed value in the memory 110, or may be calculated using the number N of pulses determined in S220.

That is, the angle α may have a radian value (that is, the unit of rad) that is proportional to kπ (where k is a real or natural number having a value greater than 0, and π is the pi) and is inversely proportional to the number N of pulses. Accordingly, the processor 120 may calculate the angle α according to Equation 1 below using the relationship.

α=kπ/N (Equation 1)

In one example, k may be 2. That is, when the certain period of time in S220 corresponds to the time for the specific tire to rotate once, k may be 2. However, the k value is not limited thereto.

In addition, the angular velocity ω may have a value (the unit of rad/s) that is proportional to the angle α and is inversely proportional to the time interval Tᵢ between each pulse. Accordingly, according to Equation 2 below, the processor 120 may calculate the angular velocity ω according to Equation 2 below using the relationship.

ω=α/Tᵢ (Equation 2)

According to the performance of S230, a plurality of angular velocities ω over time for the specific tire may be calculated. That is, the angular velocity ω may be calculated for a plurality of consecutive certain periods of times. Hereinafter, a process of calculating the angular velocities ω over time in this way may be differently referred to as “first sampling”, and accordingly, the angular velocities ω calculated over time may be differently referred to as “primary samples.”

In S240, the processor 120 performs Fourier transform on each of the angular velocities ω over time. In this case, Fourier transform is an operation that converts a signal according to the angular velocity ω sampled in time into a signal in frequency space. In this case, since the signal according to the angular velocity ω corresponds to a discrete signal, it may be desirable to perform Fast Fourier Transform (FFT).

Meanwhile, the Fourier transform may be performed on the time domain of a primary sampled signal (that is, a signal of the primary samples). However, in the case of the primary sampled signal, the number of signals is insufficient, so that a desired result may not clearly appear during Fourier transform. Accordingly, the processor 12 may perform a secondary sampling operation of increasing the number of sampling signals using the primary sample before performing S240.

FIG. 3 shows one example of primary and secondary samples.

In this case, the secondary samples further contain samples for additional angular velocities ω at a plurality of regular intervals between neighboring primary samples. The process may be referred to as a “secondary sampling,” and the additional angular velocities ω added accordingly may be referred to as the “secondary samples.”

For the secondary sampling, the processor 120 may further add secondary samples at a plurality of regular intervals between neighboring primary samples using various interpolation methods. In one example, as the interpolation method, a linear interpolation method, a Lagrangian polynomial interpolation method, or the like, may be used, but the interpolation method is not limited thereto.

When the secondary sampling is performed, the Fourier transform according to S240 may be performed on the time domain of the signal according to the first and second samples.

In S250, the processor 120 determines whether the tire rotation of a specific tire is imbalanced based on signal magnitudes of frequency signals included in a reference region R according to the Fourier transform in a frequency domain. In one example, the processor 120 determines whether the tire rotation of the specific tire is imbalanced based on a representative value of frequency signals included in a reference region R according to the Fourier transform in a frequency domain.

In this case, the reference region R is a region corresponding to a higher frequency range than a rotational frequency component F_{R} for the specific tire of the vehicle in the frequency domain according to Fourier transform. In this case, the reference region R may include at least one (more preferably a plurality or more) harmonic component F_{H} for the rotational frequency component F_{R} having a higher frequency than the rotational frequency component F_{R}.

The rotational frequency component F_{R} is a frequency signal component (Hz unit) that is basically generated in the frequency domain according to the rotation of a specific tire. Since the rotational frequency component F_{R} is proportional to a traveling speed V_{A} of the vehicle and inversely proportional to a circumference length L_{T} of the specific tire, the rotational frequency component F_{R} has the relationship of Equation 3 below.

FR=cV_{A}/L_{T} (Equation 3)

Here, c is a coefficient and may be a real number other than 0. In one example, c may be 1 to simplify Equation 3, but is not limited thereto. In addition, the unit of V_{A} is mm/s, and the unit of L_{T} is mm.

The processor 120 may identify the rotational frequency component F_{R} using Equation 3, or identify the largest frequency signal component in a relatively low frequency domain in the Fourier transformed frequency domain to identify the identified frequency signal component to be the rotational frequency component F_{R}.

Meanwhile, when tire rotation imbalance occurs in the specific tire, in the reference region R, which is a relatively higher frequency range than the rotational frequency component F_{R} in the Fourier transformed frequency domain, the signal magnitude of the harmonic component F_{H} for the rotational frequency component F_{R} significantly increases.

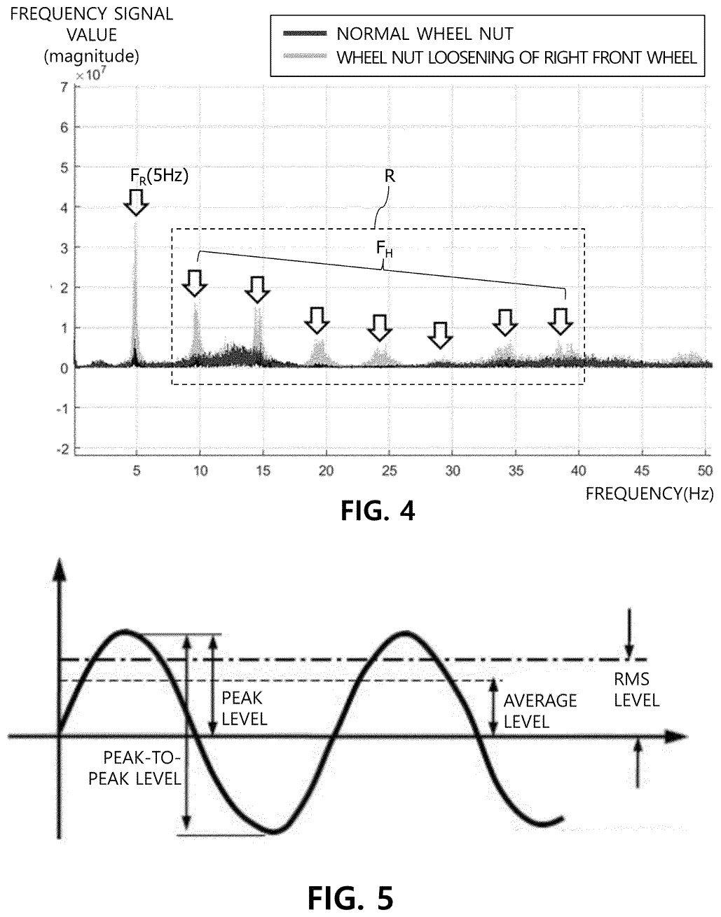

FIG. 4 shows one example of angular velocities ω calculated in the case of a vehicle speed of 37 km/h in a normal state without wheel nut loosening and in a state of wheel nut loosening of a right front wheel, respectively, in a frequency domain.

That is, referring to FIG. 4, in order to identify frequency noise of tire rotation imbalance, under the same speed (37 km/h) condition, while changing only the state of a wheel nut, the angular velocity ω was identified based on sensor data from the wheel speed sensor 20, and then, the FFT was performed on the angular velocity ω.

In this case, since the radius of the tire is 327.7 mm, the circumference of the tire is 2058.8 mm by 2π×x 327.7 mm. Accordingly, since the frequency of the rotational frequency component F_{R} is calculated by converting the traveling speed of 37 km/h into a value of the unit of mm/s and dividing the converted value by 2058.8 mm, the frequency is approximately 5 Hz. Referring to FIG. 4, it can be confirmed that the 5 Hz frequency signal has a large signal value in a relatively low frequency domain, and the signal value may be identified as a rotational frequency component F_{R}.

That is, according to FIG. 4, it can be confirmed that, unlike the normal state, in the tire rotation imbalance state, as a magnitude of the frequency signal of approximately 5 Hz, which is the rotational frequency component F_{R}, increases, a magnitude of the frequency signal of the harmonic component F_{H} for the corresponding rotational frequency component F_{R} in the reference region R also increases. Of course, it can be confirmed that magnitudes of the remaining frequency signals (that is, signals corresponding to noise) in the reference region R also increase overall. Accordingly, in S250, a determination as to whether tire rotation imbalance occurs may be made based on the information. For reference, in FIG. 4, for convenience, only the positive portion of the frequency signal value is shown and the negative portion is not shown.

Accordingly, the processor 120 may determine whether the tire rotation of the specific tire is imbalanced depending on whether the signal magnitude of the harmonic component F_{H} for the rotational frequency component F_{R} increases in the reference region R. In addition, the processor 120 may also determine whether the tire rotation of the specific tire is imbalanced depending on whether signal magnitudes of the other remaining frequency signals increase in the reference region R.

Meanwhile, the processor 120 may identify a representative value for the magnitudes of frequency signals included in the reference region R. This is for determining whether the frequency signal of the harmonic component F_{H} and the remaining frequency signals in the reference region R have increased due to tire rotation imbalance.

However, it may be desirable for the reference region R to include at least one harmonic component F_{H}. In this case, the representative value may be a representative value of the signal magnitudes for frequency signals including the harmonic component F_{H} included in the reference region R.

FIG. 5 shows a conceptual view of a root mean square (RMS), a peak-to-peak level, a peak level, and an average level.

In this case, the representative value is a value representing the magnitudes of the frequency signals in the reference region R. In one example, the representative value may include at least one of a root mean square (RMS) value, a peak-to-peak level value, a peak level value, or an average level value for the frequency signals in the reference region R, but is not limited thereto. Of course, a plurality of representative values of different types may be included.

In one example, each of a first representative value that is a representative value for the frequency signal of the harmonic component F_{H} included in the reference region R and a second representative value that is a representative value for frequency signals other than the harmonic component F_{H} included in the reference region R may be identified.

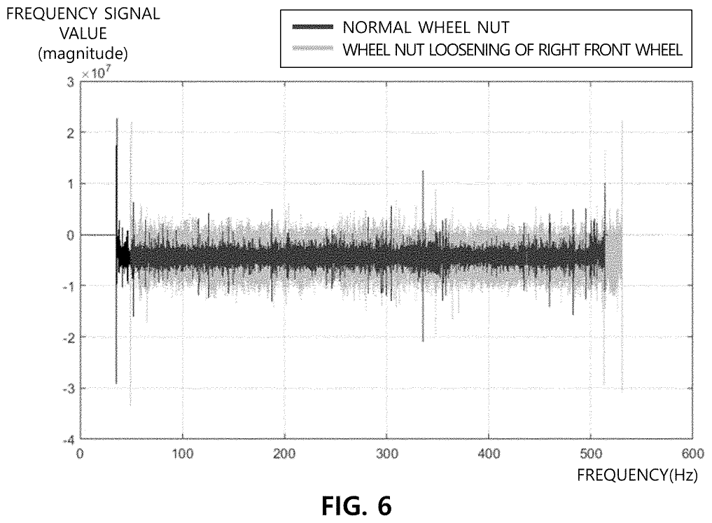

FIG. 6 shows one example of frequency signals passing a band pass filter (BPF) in FIG. 4. For reference, in FIG. 6, both negative and positive portions of the frequency signal value are shown.

Further, referring to FIG. 6, the processor 120 may apply a band pass filter (BPF) to the reference region R including at least one harmonic component F_{H}, and then identify a representative value of the frequency signals therefor. That is, a bandwidth of the BPF may include a bandwidth of the corresponding reference region R.

Then, the processor 120 may determine whether tire rotation imbalance occurs in a specific tire based on the identified representative value. That is, the processor may determine whether tire rotation imbalance occurs by comparing the representative value with a preset reference value stored in the memory 110.

That is, when the identified representative value is smaller than the reference value, the processor 120 determines that tire rotation imbalance does not occur in the specific tire. This is because when the representative value is smaller than the reference value, it is indicated that the signal magnitudes for the harmonic component F_{H} and the like in the reference region R do not increase that much.

On the other hand, when the identified representative value is greater than the reference value, the processor 120 determines that tire rotation imbalance occurs in the specific tire. This is because when the representative value is greater than the reference value, it is indicated that the signal magnitudes for the harmonic component F_{H} and the like in the reference region R significantly increase that much.

In one example, when the first and second representative values are identified together, respective reference values for the first and second representative values may be applied, and a determination as to whether tire rotation imbalance occurs may be made based on the application. In this case, when the first representative value exceeds the first reference value and the second representative value also exceeds the second reference value, the processor 120 may determine that tire rotation imbalance has occurred in the specific tire. On the other hand, when the first representative value is less than the first reference value or the second representative value is less than the second reference value, the processor 120 may determine that the tire rotation imbalance does not occur in the specific tire.

Meanwhile, the processor 120 may generate a control signal for notification of imbalance when the processor 120 determines that the tire rotation imbalance occurs in S250. That is, the processor 120 may generate a control signal to output a warning signal for the corresponding notification on a dashboard, a display, or the like, in the vehicle, or generate a control signal to output a warning sound for the corresponding error notification through a speaker or the like in the vehicle. Accordingly, a tire-related notification may be transmitted to a driver.

Since the present disclosure configured as described can provide a new technology capable of detecting rotation imbalance of a tire using an existing wheel speed sensor 20 without a separate additional sensor, the present disclosure has an advantage of being efficient and cost-effective. In addition, since the present disclosure can detect rotation imbalance separately for each tire, the present disclosure has the advantage of being highly practical. In addition, since the present disclosure can detect tire rotation imbalance with relatively high accuracy, the present disclosure has an advantage of preventing a vehicle accident that may occur due to specific tire rotation imbalance in advance.

Since the present disclosure can provide a new technology capable of detecting rotation imbalance of a tire using an existing wheel speed sensor without a separate additional sensor, the present disclosure has an advantage of being efficient and cost-effective.

In addition, since the present disclosure can detect rotation imbalance separately for each tire, the present disclosure has the advantage of being highly practical.

In addition, since the present disclosure can detect tire rotation imbalance with relatively high accuracy, the present disclosure has an advantage of preventing a vehicle accident that may occur due to specific tire rotation imbalance in advance.

The effects obtainable from the present disclosure are not limited to the effects mentioned above, and other effects not mentioned may be clearly understood by those of ordinary skill in the art to which the present disclosure belongs from the following description.

Although the embodiments of the present disclosure have been described, the spirit of the present disclosure is not limited by the embodiments presented in the present specification, and those skilled in the art who understand the spirit of the present disclosure will be able to easily suggest other embodiments by adding, changing, deleting, or supplementing components within the scope of the same spirit. However, the other embodiments will also be construed as falling within the scope of the spirit of the present disclosure.

What is claimed is:

1. A device provided in a vehicle, comprising:
a memory; and
a processor configured to perform processing to detect whether tire rotation imbalance occurs using information stored in the memory,
wherein the processor is configured to:
identify an angular velocity (ω) of each of a plurality of tires of the vehicle over time using a sensor signal from a wheel speed sensor installed on the tire;
perform Fourier transform on the angular velocity (ω); and
determine whether the tire rotation is imbalanced based on signal magnitudes of frequency signals included in a reference region according to the Fourier transform in a frequency domain.

2. The device of claim 1, wherein the processor identifies the angular velocity (ω) based on the number of pulses (N) included in the sensor signal and a time interval (Tᵢ) between each pulse.

3. The device of claim 2, wherein the pulse is a signal corresponding to a tooth provided on a tone wheel rotating in conjunction with the tire.

4. The device of claim 1, wherein the processor samples secondary samples for a plurality of additional angular velocities between each primary sample based on primary samples according to each of the identified angular velocities, and then performs Fourier transform on the primary and secondary samples.

5. The device of claim 4, wherein the secondary samples are sampled using an interpolation method.

6. The device of claim 1, wherein the processor divides a region with a higher frequency range than a rotational frequency component (F_{R}) of the tire according to a traveling speed in the frequency domain into the reference region.

7. The device of claim 6, wherein a frequency of the rotational frequency component (F_{R}) in the frequency domain is proportional to the traveling speed and inversely proportional to a circumference length of the tire.

8. The device of claim 6, wherein the processor determines whether the tire rotation is imbalanced according to whether a signal magnitude of a harmonic component for the rotational frequency component in the reference region increases more than a reference.

9. The device of claim 8, wherein the processor determines whether the tire rotation is imbalanced according to whether signal magnitudes of the harmonic component and other frequency signals in the reference region increase more than the reference.

10. The device of claim 6, wherein the processor identifies a representative value for the magnitudes of the frequency signals included in the reference region and determines whether the tire rotation is imbalanced according to whether the identified representative value increases more than the reference.

11. The device of claim 10, wherein the representative value includes at least one of a root mean square (RMS) value, a peak-to-peak level value, a peak level value, or an average level value for the frequency signals in the reference region.

12. The device of claim 6, wherein the processor applies a band pass filter (BPF) to the reference region.

13. The device of claim 1, wherein the processor generates a control signal for notification of imbalance when it is determined that the tire rotation imbalance occurs.

14. A method performed by a device provided in a vehicle to detect whether tire rotation imbalance occurs, comprising:
identifying an angular velocity (ω) of each of a plurality of tires of the vehicle over time using a sensor signal from a wheel speed sensor installed on the tire;
performing Fourier transform on the angular velocity (ω); and
determining whether the tire rotation is imbalanced based on signal magnitudes of frequency signals included in a reference region according to the Fourier transform in a frequency domain.

15. The method of claim 14, wherein in the identifying, the angular velocity (ω) is identified based on the number of pulses (N) included in the sensor signal and a time interval (Tᵢ) between each pulse.

16. The method of claim 14, wherein in the performing, secondary samples for a plurality of additional angular velocities between each primary sample are sampled based on primary samples according to each of the identified angular velocities, and then Fourier transform is performed on the primary and secondary samples.

17. The method of claim 14, wherein the reference region is a region with a higher frequency range than a rotational frequency component (F_{R}) of the tire according to a traveling speed in the frequency domain.

18. The method of claim 14, wherein in the determining, a determination as to whether the tire rotation is imbalanced is made according to whether a signal magnitude of a harmonic component for the rotational frequency component in the reference region increases more than a reference.

19. The method of claim 14, wherein in the determining, a representative value for the magnitudes of the frequency signals included in the reference region is identified and a determination as to whether the tire rotation is imbalanced is made according to whether the identified representative value increases more than the reference.

20. A vehicle comprising:
a wheel speed sensor installed on each of a plurality of tires to detect a sensor signal; and
a detection device configured to detect whether tire rotation imbalance occurs using the sensor signal,
wherein the detection device is configured to:
identify an angular velocity (ω) of each of the plurality of tires of the vehicle over time using the sensor signal from the wheel speed sensor installed on the tire;
perform Fourier transform on the angular velocity (ω); and
determine whether the tire rotation is imbalanced based on signal magnitudes of frequency signals included in a reference region according to the Fourier transform in a frequency domain.
